(19) United States
(12) Patent Application Publication
(10) Pub. No.: US 2014/0280170 A1
(43) Pub. Date: Sep. 18, 2014

(54) COMPUTER-READABLE STORAGE MEDIUM STORING A GROUPING SUPPORT PROGRAM, GROUPING SUPPORT METHOD AND GROUPING SUPPORT SERVER

(71) Applicant: FUJITSU LIMITED, Kawasaki-shi (JP)

(72) Inventors: Toshio Tanaka, Yokohama (JP); Hidehiko Mayumi, Kawasaki (JP); Takeaki Kobayashi, Yokohama (JP); Takehiro Nabae, Chigasaki (JP); Masahiro Kawasaki, Kawasaki (JP)

(73) Assignee: FUJITSU LIMITED, Kawasaki-shi (JP)

(21) Appl. No.: 14/177,950

(22) Filed: Feb. 11, 2014

(30) Foreign Application Priority Data
Mar. 18, 2013 (JP) 2013-055486

(51) Int. Cl. G06F 17/30

(52) U.S. Cl. CPC G06F 17/30598
USPC 707/739

(57) ABSTRACT

A computer-readable storage medium storing a grouping support program of opinion information that, when executed by a computer, performs a grouping support method includes specifying a related opinion information related to a first opinion information and a second opinion information among a plurality of collected opinion information based on a related word guided from the first opinion information and the second opinion information selected from the plurality of collected opinion information; and grouping the specified related opinion information in the same group as the first opinion information and the second opinion information.

### CROSS-REFERENCE TO RELATED APPLICATION

This application is based upon and claims the benefit of priority from the prior Japanese Patent Application No. 2013-055486 filed on Mar. 18, 2013, the entire contents of which are incorporated herein by reference.

### FIELD

The present disclosure relates to a grouping support program, a grouping support method and a grouping support server that perform grouping of opinions input with respect to an assignment.

### BACKGROUND

A verification test of the next-generation education using an electronic terminal such as a tablet PC is being conducted and thus, it is anticipated that the next-generation education will be spread out nationwide.

A type of education includes a discussion conducted between students in the class. It is conceived that the discussion in the next-generation education will be conducted using the electronic terminal. A type of the discussion is known in which opinions with respect to an assignment input to the electronic terminal by the student are collectively received to be displayed on a screen of the electronic terminal for teacher, the content of the opinion selected by a teacher among the displayed opinions is set as a subject and then, the discussion is conducted.

There has been a need to group an opinion selected by the teacher as a subject and another opinion related to the selected opinion to display the grouped opinions arranged by a group unit. There is known a grouping method such as, for example, a method of manually grouping the opinions of students by the teacher, or a method of grouping the opinions of students by digitalizing the degree of relevancy of the opinions of the respective students and grouping the opinions according to the degree of relevancy.

See, for example, Japanese Patent Application Laid-Open No. H7-98687.

### SUMMARY

According to one aspect of the embodiments, a computer-readable storage medium storing a grouping support program of opinion information that, when executed by a computer, performs a grouping support method includes specifying a related opinion information related to a first opinion information and a second opinion information among a plurality of collected opinion information based on a related word guided from the first opinion information and the second opinion information selected from the plurality of collected opinion information; and grouping the specified related opinion information in the same group as the first opinion information and the second opinion information.

The object and advantages of the invention will be realized and attained by means of the elements and combinations particularly pointed out in the claims. It is to be understood that both the foregoing general description and the following detailed description are exemplary and explanatory, and are not restrictive of the invention, as claimed.

### BRIEF DESCRIPTION OF DRAWINGS

FIG. 1 is a view illustrating an example of a configuration of a grouping support system.

FIG. 2 is a view illustrating an example of a hardware configuration of a teacher terminal.

FIG. 3 is a view illustrating an example of a student database.

FIG. 4 is a view illustrating an example of an assignment database.

FIG. 5 is a first view illustrating an example of an opinion database.

FIG. 6 is a view illustrating an example of a label database.

FIG. 7 is a view illustrating an example of a synonym dictionary.

FIG. 8 is a view explaining the function of the teacher terminal.

FIG. 9 is a first flowchart illustrating the operations of the teacher terminal.

FIG. 10 is a view illustrating an example of an assignment selection monitor screen displayed on the teacher terminal.

FIG. 11 is a view illustrating an example of an assignment monitor screen displayed on a student terminal.

FIGS. 12A, 12B and 12C are a second flowchart illustrating the operations of the teacher terminal.

FIG. 13 is a view illustrating an example of an opinion display monitor screen.

FIG. 14 is a view illustrating an example of the opinion display monitor screen in which a representative opinion is selected.

FIG. 15 is a view illustrating an example of the opinion display monitor screen which is in an opinion selection mode.

FIG. 16 is a view illustrating an example of the opinion display monitor screen in which an opinion required for being a selected opinion is selected.

FIG. 17 is a second view illustrating an example of the opinion database.

FIG. 18 is a view illustrating an example of the opinion display monitor screen in which a relating line is displayed.

FIG. 19 is a view explaining movement of the selected opinion and a related opinion.

FIG. 20 is a view illustrating an example of the opinion display monitor screen in which movement of the selected opinion and the related opinion has been completed.

FIG. 21 is a flowchart explaining a process of a label display unit.

FIG. 22 is a view illustrating an example of the opinion display monitor screen in which a label information selection menu is displayed.

FIG. 23 is a view illustrating an example of the opinion display monitor screen in which label information is selected from the label information selection menu.

FIG. 24 is a view illustrating an example of the opinion display monitor screen in which the selected label information is displayed on a representative opinion display area.

FIG. 25 is a view illustrating an example of the opinion display monitor screen in which manipulation of the relating line deletion is performed.

FIG. 26 is a view illustrating an example of the opinion display monitor screen in which the relating line is deleted.

FIG. 27 is a view illustrating an example of the opinion database in which a plurality of representative opinions are selected.

FIG. 28 is a view illustrating an example of the opinion display monitor screen in which a plurality of representative opinions are selected.

FIG. 29 is a view illustrating an example of an unfolding display monitor screen in which the opinion is unfolded and displayed.

### DESCRIPTION OF EMBODIMENTS

Hereinbelow, exemplary embodiments will be described with reference to accompanying drawings. FIG. 1 is a view illustrating an example of a configuration of a grouping support system.

A grouping support system 100 of the present embodiment includes a grouping support server 200 and a plurality of electronic terminals 300. The grouping support server 200 and the plurality of electronic terminals 300 of the present embodiment are connected with each other through a network.

The grouping support server 200 supports grouping of opinions input from each electronic terminal 300 with respect to an assignment displayed in each electronic terminal 300 in the grouping support system 100 of the present embodiment. The grouping in the present embodiment is an arrangement of opinions in which the opinions determined as having a relevancy when viewed from a predetermined viewpoint are grouped to form a group.

The grouping support system 100 of the present embodiment may be used in a discussion conducted between the students in, for example, the class. When the grouping support system 100 is used in the class, the grouping support server 200 serves as a terminal for teacher and the electronic terminal 300 serves as a terminal for student. Accordingly, in the following description, the grouping support server 200 and the electronic terminal 300 are referred to as a teacher terminal 200 and student terminal 300, respectively.

Each of the teacher terminal 200 and the student terminal 300 may be, for example, a tablet PC. Further, the teacher terminal 200 may be, for example, a desktop computer or a notebook computer and the student terminal 300 may be a notebook computer.

The teacher terminal 200 of the present embodiment includes a student database 210, an assignment database 220, an opinion database 230, a label database 240, a similar word dictionary 250, and is installed with program for teacher 260. The program for teacher 260 of the present embodiment includes an assignment execution program 270 and a grouping support program 280.

Further, the student terminal 300 of the present embodiment is installed with a program for student 310.

The teacher terminal 200 groups opinions of each student for an assignment according to viewpoint determined by a teacher and displays the opinions by a group unit in the grouping support system 100 of the present embodiment. Specifically, a viewpoint of a representative opinion is determined using a related word which is common to both the representative opinion determined as appropriate for a subject and the opinion (referred to as a selected opinion) of the other students determined and selected as related to the representative opinion by the teacher from the opinion of each student and opinions related to the representative opinion are grouped in the present embodiment. Details of the related words will be described in later.

FIG. 2 is a view illustrating an example of a hardware configuration of a teacher terminal. The teacher terminal 200 of the present embodiment includes a display manipulation device 21, a drive device 22, an auxiliary storage device 23, a memory device 24, an operation processing device 25 and an interface device 26 that are connected with one another through a bus B.

The display manipulation device 21 is, for example, a touch panel, and is used to input various signals and display various information.

The interface device 26 includes, for example, a modem, or a LAN card, and is used for connecting to the network.

The program for teacher 260 constitutes at least a portion of various programs that control the teacher terminal 200. The program for teacher 260 is provided by, for example, a distribution of the recording medium 27 or download from the network. The recording medium 27 having the program for teacher 260 recorded therein may utilize various types of recording mediums such as, for example, a CD-ROM, a flexible disk, and an magneto-optical disk, which records information optically, electrically and magnetically, and a semiconductor memory such as, for example, a ROM, and a flash memory, which records information electrically.

Further, when the recording medium 27 having the program for teacher 260 recorded therein is set in the drive device 22, the program for teacher 260 is installed in the auxiliary storage device 23 from the recording medium 27 through the drive device 22. The program for teacher 260 downloaded from the network is installed in the auxiliary storage device 23 through the interface device 26.

The auxiliary storage device 23 stores, for example, necessary files and data while storing the installed program for teacher 260. The memory device 24 reads out and stores the program for teacher 260 from the auxiliary storage device 23 when a computer is activated. Also, the operation processing device 25 implements various processes as described below according to the program for teacher 260 stored in the memory device 24.

Further, the teacher terminal 200 of the present embodiment may be, for example, a desktop computer or a notebook computer. In this case, the teacher terminal 200 includes an input device, such as a keyboard or a mouse, and an output device, such as a display, instead of the display manipulation device 21.

A hardware configuration of the student terminal 300 of the present embodiment is similar to that of the teacher terminal 200 and thus, descriptions thereof will be omitted.

Hereinbelow, each database and a similar word dictionary 250 stored in the teacher terminal 200 will be described with reference to FIG. 3 to FIG. 7.

FIG. 3 is a view illustrating an example of a student database. The student database 210 of the present embodiment is registered by, for example, the teacher who manipulates the teacher terminal 200 in advance. A student identifier (student ID) allocated for each student terminal 300, a student name, and an IP address of the student terminal 300 are stored to be associated with each other in the student database 210. The IP address is information which identifies the student terminal 300.

FIG. 4 is a view illustrating an example of an assignment database. The assignment database 220 of the present embodiment is registered by, for example, the teacher who manipulates the teacher terminal 200 in advance. An assignment ID allocated for each assignment, a content of assignment and an assignment submission time set for each assignment are stored to be associated with each other in the assignment database 220 of the present embodiment.

FIG. 5 is a first view illustrating an example of an opinion database. The student ID and the content of the opinion input by the student for each assignment ID are stored to be associated with each other in the opinion database 230 of the present embodiment. Further, a keyword extracted from the content of the opinion and a similar word associated with the keyword is stored to be associated with the student ID in the opinion database 230 of the present embodiment. The keyword and the similar word are stored in the opinion database 230 in a process of an assignment execution program 270 to be described below.

Further, a representative opinion flag, a representative opinion, a selected opinion flag, and a selected opinion are associated with the student ID in the opinion database 230. The representative opinion flag, the representative opinion, the selected opinion flag, and the selected opinion are stored in the opinion database 230 in a process of a grouping support program 280 to be described below.

FIG. 6 is a view illustrating an example of a label database. A label database 240 is registered by, for example, the teacher who manipulates the teacher terminal 200. Label information indicating a viewpoint when opinions are grouped is stored in the label database 240. The label database 240 of the present embodiment is referred to when the label is allocated to the opinions grouped by the process of the grouping support program 280 to be described below.

FIG. 7 is a view illustrating an example of a similar word dictionary. A plurality of words having similar meaning are stored to be associated with one another as a single pattern in the similar word dictionary 250 of the present embodiment. In an example of FIG. 7, “cost of living”, “economy”, “money” and “income” are set to pattern 1, “life”, “biosis”, “abortion” and “death” are set to pattern 2, “health”, “disease”, “pregnant of mother” and “after-effect” are set to pattern 3. The words stored in the similar word dictionary 250 are stored in the opinion database 230 by the process of the grouping support program 280 to be described below. Further, the similar words are illustrated in italics in FIG. 5.

Next, the function of the teacher terminal 200 of the present embodiment will be described with reference to FIG. 8. The processes of each unit to be described below may be implemented by executing the program for teacher 260. FIG. 8 is a view explaining the function of the teacher terminal.

The teacher terminal 200 of the present embodiment includes an assignment monitor screen display unit 271, an opinion acquisition unit 272 and the opinion database update unit 273 implemented by an execution of an assignment execution program 270.

The assignment monitor screen display unit 271 displays the assignment selected from the assignment database 220 on the student terminal 300. The opinion acquisition unit 272 acquires an opinion for the assignment input in the student terminal 300 and stores the opinion in the opinion database 230. The opinion database update unit 273 updates the opinion database 230. Details of the process of the opinion database update unit 273 will be described later.

Further, the teacher terminal 200 of the present embodiment includes each unit, which will be described in the following, implemented by execution of the grouping support program 280. The teacher terminal 200 of the present embodiment includes a display control unit 281, a representative opinion reception unit 282, a selected opinion reception unit 283, a keyword acquisition unit 284, a related opinion specifying unit 285, a relating line management unit 286, and a label display unit 287.

The display control unit 281 of the present embodiment controls displaying of the display manipulation device 21 of the teacher terminal 200. The representative opinion reception unit 282 receives an opinion selected as the representative opinion in the display manipulation device 21. The representative opinion of the present embodiment corresponds to an opinion selected by the teacher as being determined to be a desirable subject of the future discussion among the opinions received from each student terminal 300. Further, when the representative opinion is selected, the representative opinion reception unit 282 of the present embodiment turns ON the representative opinion flag associated with the student ID of the student who inputs the opinion selected as the representative opinion in the opinion database 230.

The selected opinion reception unit 283 receives an opinion selected as a selected opinion in the display manipulation device 21. The selected opinion of the present embodiment corresponds to an opinion selected as having the relevancy to the representative opinion by the teacher in the opinions received from each student terminal 300. Further, when the selected opinion is selected, the selected opinion reception unit 283 turns ON the selected opinion flag associated with the student ID of the student who inputs the opinion selected as the selected opinion in the opinion database 230. Further, the selected opinion reception unit 283 stores the student ID for which the representative opinion flag is turned ON in the representative opinion column associated with the student ID of the student who inputs the opinion selected as the selected opinion.

The keyword acquisition unit 284 acquires the keyword stored in the keyword column associated with the student ID for which the selected opinion flag is turned ON.

The related opinion specifying unit 285 extracts a keyword common to keywords stored in the keyword column associated with the student ID for which the representative opinion flag is turned ON and keywords acquired from the keyword column associated with the student ID for which the selected opinion flag is turned ON. In the following description of the present embodiment, a keyword common to the keywords stored in keyword column associated with the student ID for which the representative opinion flag is turned ON and the keywords stored in keyword column associated with the student ID for which the selected opinion flag is turned ON is referred to as a related word.

The related opinion specifying unit 285 of the present embodiment specifies an opinion including the related word as a related opinion to be grouped in the same group as the representative opinion. The related opinion corresponds to an opinion related to the representative opinion when viewed from a certain viewpoint determined by the teacher. Further, the selected opinion is also grouped in the same group as the representative opinion.

The relating line management unit 286 manages displaying of the relating line indicating that the representative opinion is related with the related opinion. Details of processes of the keyword acquisition unit 284, the related opinion specifying unit 285 and the relating line management unit 286 will be described later. The label display unit 287 displays a label selected from the label database 240 with respect to the grouped opinions. Details of the process of the label display unit 287 will be described later.

Hereinbelow, operations of the teacher terminal 200 of the present embodiment will be described with reference to FIG. 9. FIG. 9 is a first flowchart illustrating operations of the teacher terminal. FIG. 9 illustrates operations of the teacher terminal 200 when the assignment execution program 270 is executed.

In the teacher terminal 200 of the present embodiment, the assignment monitor screen display unit 271 refers to the assignment database 220 to display the assignment select monitor screen on the display manipulation device 21 (step S901). Subsequently, the assignment monitor screen display unit 271 determines whether the assignment ID and the assignment transmission request are received (step S902). In the present embodiment, when the assignment is selected in the display manipulation device 21, it is determined that the assignment transmission request is received.

At step S902, when it is determined that the assignment ID and the assignment transmission request are not received, the teacher terminal 200 waits until the assignment ID and the assignment transmission request are received.

At step S902, when it is determined that the assignment ID and the assignment transmission request are received, the assignment monitor screen display unit 271 acquires the content of the assignment associated with the assignment ID selected from the assignment database 220 and transmits the acquired content of the assignment to all the student terminals 300 (step S903). When the content of the assignment is received, the student terminal 300 displays the received content of the assignment on the display manipulation device of the student terminal 300.

Subsequently, the teacher terminal 200 determines whether the opinion acquisition unit 272 receives an opinion for the assignment from the student terminal 300 (step S904). At step S904, when it is determined that the opinion acquisition unit 272 receives the opinion from the student terminal 300, the opinion database update unit 273 updates the opinion database 230 (step S905). Specifically, the opinion database update unit 273 refers to the student database 210 and acquires the student ID associated with the student terminal 300 which has transmitted the opinion. Also, the opinion database update unit 273 stores the received opinion in the opinion column of the opinion database 230 associated with the acquired student ID.

When it is determined that the opinion for the assignment is not received at step S904, the opinion acquisition unit 272 goes to step S906 t be described below.

Subsequently, the opinion acquisition unit 272 determines whether the assignment submission time is elapsed (step S906). When it is determined that the assignment submission time is not elapsed at step S906, the opinion acquisition unit 272 goes back to step S904.

When it is determined that the assignment submission time is elapsed at step S906, the opinion database update unit 273 analyzes the opinion of each student of the opinion database 230 to extract a word associated with a keyword and stores the extracted keyword in the keyword column of the opinion database 230 (step S907). Subsequently, the opinion database update unit 273 refers to the similar word dictionary 250 to store a similar word of the keyword stored in the keyword column in the keyword column of the opinion database 230 (step S908). Details of the processes of step S907 and step S908 will be described later.

FIG. 10 is a view illustrating an example of an assignment selection monitor screen displayed on the teacher terminal. The assignment select button 102, the assignment ID, the content of assignment, the assignment submission time are displayed by being corresponded to one another in the assignment select monitor screen 101 illustrated in FIG. 10. When the assignment is selected by the assignment select button 102 and the assignment transmission button 103 is depressed (touched) in the assignment select monitor screen 101, the teacher terminal 200 transmits the content of the assignment associated with the selected assignment ID to the student terminal 300.

FIG. 11 is a view illustrating an example of an assignment monitor screen displayed on the student terminal. The assignment transmitted from the teacher terminal 200 is displayed in the assignment column 112 of the assignment monitor screen 111 illustrated in FIG. 11. Further, the opinion column 113 to which an opinion for the assignment is input is displayed in the assignment monitor screen 111. When an opinion is input in the opinion column 113 and the transmission button 114 is depressed (touched), a transmission request to transmit the opinion to the teacher terminal 200 is assumed as having been received and the opinion input in the opinion column 113 is transmitted to the teacher terminal 200 in the student terminal 300.

Next, the processed of step S907 and step S908 of FIG. 9 by the opinion database update unit 273 of the present embodiment will be described with reference to FIG. 5. The opinion database 230 illustrated in FIG. 5 is an example of an opinion database after step S907 and step S908 are executed.

First, the process of step S907 will be described.

The opinion received from the student terminal 300 at step S905 of FIG. 9 is stored in the opinion database 230 of the present embodiment. The opinion database update unit 273 of the present embodiment performs, for example, a morpheme analysis with respect to the opinion of each student stored in the opinion database 230 and extracts a word from the opinion of each student. The opinion database update unit 273 extracts four words of “pregnant of mother”, “effect”, “worry”, “life” from the opinion of the student ID12301. Also, the opinion database update unit 273 stores the extracted words in the keyword column of the opinion database 230 as the keywords. The opinion database update unit 273 performs the process with respect to the opinions associated with all of the student IDs.

Next, the process of step S908 will be described.

When the keyword is extracted from each opinion, the opinion database update unit 273 of the present embodiment continuously refers to the similar word dictionary 250 to determine whether a pattern in which the word coincided with the keyword is included exists.

Specifically, the keywords associated with the student ID12301 are four words of “pregnant of mother”, “effect”, “worry”, “life”, for example, in the opinion database 230 illustrated in FIG. 5. The pattern which includes a word which coincides with any one of the four keywords is pattern 2 and pattern 3 in the similar word dictionary 250. Accordingly, the opinion database update unit 273 stores the words included in pattern 2 and pattern 3 in the keyword column associated with the student ID12301. Accordingly, ten words of “pregnant of mother”, “effect”, “concern”, “life”, “health”, “disease”, “after-effect”, “biosis”, “abortion” and “death” are stored in the keyword column associated with the student ID12301 in an example of FIG. 5.

The opinion database update unit 273 of the present embodiment performs the process for the opinion associated with all the student IDs.

Next, operations of the teacher terminal 200 of the present embodiment will be described with reference to FIGS. 12A, 12B and 12C. FIGS. 12A, 12B and 12C are a second flowchart illustrating operations of the teacher terminal. FIGS. 12A, 12B and 12C illustrate operations of the teacher terminal 200 when the grouping support program 280 is executed.

In the teacher terminal 200 of the present embodiment, the display control unit 281 displays each opinion stored in the opinion database 230 in the display manipulation device 21 in a matrix shape (step S1201). Further, a device which displays an opinion may be, for example, the display manipulation device 21 or a projector connected to the teacher terminal 200. In the present embodiment, it is desirable that the device which displays the opinion is, for example, an electronic blackboard which can be read by all the students and the teachers. Further, in the present embodiment, the same monitor screen as the monitor screen displayed in the display manipulation device 21 of the teacher terminal 200 may be displayed in a screen by, for example, a projector. The following description will be made in an assumption that displaying of the display manipulation device 21 is reflected in displaying of the electronic blackboard or the screen and the display control unit 281 controls displaying of the display manipulation device 21 of the teacher terminal 200.

The representative opinion reception unit 282 determines whether selection of the representative opinion among the opinions displayed in a matrix shape in the display manipulation device 21 is received in the teacher terminal 200 (step S1202). When it is determined that the selection of the representative opinion is received at step S1202, the representative opinion reception unit 282 turns ON the representative opinion flag associated with student ID selected as the representative opinion in the opinion database 230 (step S1203). Subsequently, the display control unit 281 displays and highlights the selected representative opinion in a monitor screen (hereinafter, the opinion display monitor screen) displayed at step S1201 (step S1204).

When it is determined that the selection of the representative opinion is not received at step S1202, the representative opinion reception unit 282 determines whether the representative opinion already exists (step S1205). Specifically, the representative opinion reception unit 282 determines whether there is an opinion for which the representative opinion flag is turned ON in the opinion database 230. When it is determined that the representative opinion does not exist at step S1205, the representative opinion reception unit 282 goes back to step S1202. When it is determined that the representative opinion already exists at step S1205, the teacher terminal 200 proceeds to step S1206 to be described below.

The selected opinion reception unit 283 determines whether the opinion display monitor screen goes into an opinion selection mode in the teacher terminal 200 (step S1206). The opinion selection mode is a mode that causes the teacher to select an opinion required for being a selected opinion in the opinion display monitor screen. In the present embodiment, the opinion selection mode may be an opinion selection mode which causes the teacher to select, for example, when a predetermined manipulation is performed within an area in which the representative opinion is displayed (hereinafter, the representative opinion display area) in the opinion display monitor screen.

When it is determined that the opinion display monitor screen goes into the opinion selection mode at step S1206, the display control unit 281 displays a message which prompts to select an opinion related to the representative opinion in the display manipulation device 21 (step S1207). When it is determined that the opinion display monitor screen does not go into the opinion selection mode at step S1206, the process proceeds to step S1215 to be described below.

Subsequently, the selected opinion reception unit 283 determines whether the representative opinion and an opinion required for being a selected opinion in the opinion display monitor screen (step S1208). When it is determined that the selected opinion is not selected at step S1208, the selected opinion reception unit 283 waits until the opinion is selected as a selected opinion. When it is determined that the opinion is selected as the selected opinion at step S1208, the selected opinion reception unit 283 turns ON the selected opinion flag associated with the student ID of which the opinion is selected in the opinion database 230 at step S1208. Further, the selected opinion reception unit 283 stores the student ID of which the representative opinion flag is turned ON in the representative opinion column associated with the student ID of which the opinion is selected at step S1208 (step S1209). In the following description, an opinion for which the selected opinion flag is turned ON is referred to as the selected opinion.

Subsequently, the keyword acquisition unit 284 acquires the keyword stored in the keyword column associated with the student ID of which the selected opinion flag is turned ON from the opinion database 230 (step S1210). Subsequently, the related opinion specifying unit 285 determines whether the related word (the same keyword among the keywords contained in the representative opinion and the selected opinion) exists in the keywords acquired at step S1210 (step S1211). When it is determined that the related word does not exist at step S1211, the process proceeds to step S1218 to be described below.

When it is determined that the related word exists at step S1211, the related opinion specifying unit 285 determines whether a student ID, which includes the keyword coincided with the related word, except for the students who wrote representative opinion and the selected opinion exists in the keyword column in the opinion database 230 (step S1212). When it is determined that the corresponding student ID does not exist at step S1212, the process proceeds to step S1218 to be described below.

When it is determined that the student ID exists at step S1212, the related opinion specifying unit 285 specifies the opinion of the corresponding student ID as a related opinion related to the representative opinion.

At a step subsequent to step S1212, the related opinion specifying unit 285 stores the student ID of the student who inputs the selected opinion in the selected opinion column associated with the student ID of the student who input the related opinion in the opinion database 230 (step S1213).

Subsequently, the relating line management unit 286 causes the display control unit 281 to display the relating line which connects the related opinion and the selected opinion in the opinion display monitor screen (step S1214). Subsequently, the relating line management unit 286 determines whether a trajectory input which trespasses the relating line by, for example, a pointer, is detected (step S1215). Details of the relating line will be described later.

When it is determined that the corresponding input is detected at step S1215, the related opinion specifying unit 285 deletes the student ID stored in the selected opinion column associated with the student ID of the student who input the related opinion in the opinion database 230 (step S1216). When it is determined that the corresponding input is not detected at step S1215, the process proceeds to step S1218 to be described below. As a result, the process of step S1216 is a process in which the relevancy is removed after an indication that the opinion is an unrelated opinion is received from the teacher.

At a step subsequent to step S1216, the relating line management unit 286 deletes the relating line which connects the selected opinion and the related opinion for which the student ID is deleted at step S1216 in the opinion display monitor screen (step S1217). Details of the relating line will be described later.

Subsequently, the display control unit 281 determines whether the selected opinion and the related opinion are moved to the representative opinion display area in the opinion display monitor screen (step S1218). Specifically, the display control unit 281 determines whether the manipulation of dragging the selected opinion to the representative opinion display area is performed in the opinion display monitor screen. Further, in the present embodiment, when the manipulation of dragging the selected opinion to the representative opinion display area is performed, since the related opinion connected to the selected opinion by the relating line is also being continued to the selected opinion and thus, the related opinion is dragged and moved to the representative opinion the display area.

When it is determined that the selected opinion and the related opinion are moved at step S1218, the display control unit 281 displays the selected opinion and the related opinion in such a manner that the opinions are overlapped with and positioned below the representative opinion in the representative opinion display area (step S1219). When it is determined that the selected opinion and the related opinion are not moved at step S1218, the process proceeds to step S1220 to be described below.

At a step subsequent to step S1219, the label display unit 287 determines whether a label display request for the representative opinion is received in the opinion display monitor screen (step S1220). When it is determined that the label display request is received step S1220, the label display unit 287 performs a label display process (step S1221). Details of the label display process by the label display unit 287 will be described later.

When it is determined that the label display request is not received at step S1220, the display control unit 281 determines whether the opinion unfolding display request is received (step S1222). When it is determined that the opinion unfolding display request is received at step S1222, the display control unit 281 displays the selected opinion and the related opinion with being centered around the representative opinion (step S1223). When it is determined that the opinion unfolding display request is not received at step S1222, the process proceeds to step S1226. At step S1226, the display control unit 281 determines whether a display end request is received (step S1226). When it is determined that the display end request is received at step S1226, the teacher terminal 200 ends the process of the grouping support program 280. When it is determined that the display end request is not received at step S1226, the teacher terminal 200 goes back to step S1202.

At a step subsequent to step S1223, the display control unit 281 determines whether a request to restore displaying of the monitor screen to the opinion display monitor screen displayed initially (step S1224). When it is determined that the corresponding request is received at step S1224, the display control unit 281 restores displaying of the opinion to an initial opinion unfolding monitor screen displayed in a matrix shape (step S1227), and goes back to step S1202.

When it is determined that the corresponding request is not received at step S1224, the display control unit 281 determines whether the display end request is received (step S1225).

When it is determined that the display end request is not received at step S1225, the display control unit 281 goes back to step S1224. When it is determined that the display end request is received at step S1225, the teacher terminal 200 ends the process of the grouping support program 280.

Hereinbelow, the operations of the teacher terminal 200 when the grouping support program 280 of the present embodiment is executed will be described with reference to figures in detail.

FIG. 13 is a view illustrating an example of an opinion display monitor screen. The opinion display monitor screen 131 illustrated in FIG. 13 is an example of a monitor screen displayed on the display manipulation device 21 of the teacher terminal 200 at step S1201 of FIG. 12A. Further, the opinion display monitor screen 131 may also be associated with the teacher terminal 200 and displayed on, for example, an electronic blackboard or a screen.

The opinions of the respective students stored in the opinion database 230 are displayed in a matrix shape in the opinion display monitor screen 131.

FIG. 14 is a view illustrating an example of the opinion display monitor screen in which the representative opinion is selected. FIG. 14 illustrates an example of the opinion display monitor screen 131A in which an opinion of Mr. DD is selected as the representative opinion. In the opinion display monitor screen 131A, for example, an area in which the opinion of Mr. DD is displayed becomes a representative opinion display area 141. Further, the representative opinion display area 141 is displayed to be emphasized, for example, by being color-displayed with a particular color in the opinion display monitor screen 131A.

FIG. 15 is a view illustrating an example of the opinion display monitor screen in which the opinion selection mode is selected. The teacher terminal 200 of the present embodiment may go into an opinion selection mode in a case where a particular manipulation is performed while a cursor is placed within the representative opinion display area 141 by, for example, a pointing device.

Specifically, in a case where, for example, a mouse is used as the pointing device, the teacher terminal 200 may be allowed to go into the opinion selection mode at the time when the cursor 142 is left-clicked by being placed within the representative opinion display area 141. When the teacher terminal 200 of the present embodiment goes into the opinion selection mode, a message 143 prompting to select an opinion required for being a selected opinion is displayed.

FIG. 16 is a view illustrating an example of the opinion display monitor screen in which an opinion required for being a selected opinion is selected. FIG. 16 illustrates an example of the opinion display monitor screen 131C in which an opinion of MR. GG is selected as the selected opinion. In the opinion display monitor screen 131C, when the cursor 142 is placed within, for example, an area in which the opinion of MR. GG is displayed, an area in which the opinion of MR. GG is displayed becomes the selected opinion display area 144. The selected opinion display area 144 may also be displayed to be highlighted in the present embodiment.

Hereinbelow, the opinion database 230 which is in a state where the representative opinion and the selected opinion are selected will be described with reference to FIG. 17. FIG. 17 is a second view illustrating an example of the opinion database. FIG. 17 illustrates an example the opinion database 230 in a case where the opinion of MR. DD is set as the representative opinion and the opinion of MR. GG is set as the selected opinion.

When referring to the student database 210, the student ID of MR. DD is 12304. Accordingly, the representative opinion flag associated with the student ID12304 is turned ON in the opinion database 230 illustrated in FIG. 17. Further, when referring to the student database 210, the student ID of MR. GG is 12307. Accordingly, in the opinion database 230 illustrated in FIG. 17, the student ID12304 of MR. DD selected as the representative opinion is stored in the representative opinion column associated with the student ID12307. Further, the selected opinion flag associated with the student ID12307 is turned ON.

Here, a process of the related opinion specifying unit 285 will be described in detail. The keywords associated with the representative opinion are “economy”, “happiness”, “cost of living”, “money” and “income” in the opinion database 230 of FIG. 17. Further, the keywords associated with the selected opinion are “money”, “hardship” “cost of living”, “economy” and “income” in the opinion database 230 of FIG. 17.

The keywords common to the keywords associated with each of the representative opinion and the selected opinion, that is, the related words are “economy”, “cost of living”, “money” and “income”.

Accordingly, the related opinion specifying unit 285 specifies the student ID for which the keywords coincided with the four related words included in the keyword column in the opinion database 230. The student ID12302 is specified as the student ID described above in an example of FIG. 17. Accordingly, the related opinion specifying unit 285 specifies the opinion associated with the student ID12302 as the related opinion. Further, the related opinion specifying unit 285 stores the student ID12307 of which the selected opinion flag is turned ON in the selected opinion column associated with the student ID12302.

That is, it may be seen that in the opinion database 230 illustrated in FIG. 17, the opinion of the student having the student ID12302 is similar to the opinion of the student having the student ID12307 and the opinion of the student having the student ID12307 is related to the opinion of the student having the student ID12304. As described above, the opinion database 230 of the present embodiment stores the relationship between the representative opinion, the selected opinion and the related opinion.

Subsequently, a case where the opinion display monitor screen 131 in which the relating line is displayed will be described with reference to FIG. 18. FIG. 18 is a view illustrating an example of the opinion display monitor screen in which a relating line is displayed.

The related opinion display area 145 corresponds to an area in which the opinion of Mr. BB who is the student having the student ID12302 is displayed in the opinion display monitor screen 131D illustrated in FIG. 18. Further, the relating line 146 connecting the selected opinion display area 144 and the related opinion display area 145 is displayed in the opinion display monitor screen 131D. Further, a single relating line 146 exists in an example of FIG. 18. However, when a plurality of related opinions exist, the plurality of relating lines directing from the selected opinion display area 144 to the plurality of related opinion display areas are displayed.

Next, the movement of the selected opinion and the related opinion will be described with reference to FIG. 19. FIG. 19 is a view explaining movement of the selected opinion and the related opinion.

In the present embodiment, when the cursor 142 is moved into, for example, the representative opinion display area 141 while placing the cursor 142 within the selected opinion display area 144 in the opinion display monitor screen 131E illustrated in FIG. 19, the selected opinion displayed in the selected opinion display area 144 is moved to the representative opinion display area 141 along the trajectory of the cursor 142. Further, the related opinion displayed in the related opinion display area 145 connected with the selected opinion display area 144 by the relating line 146 is also associated with the selected opinion and moved into the representative opinion display area 141 in the present embodiment.

That is, in the present embodiment, the related opinion connected with the selected opinion by the relating line is grouped in the same group as the representative opinion.

FIG. 20 is a view illustrating an example of the opinion display monitor screen which is in a state where movement of the selected opinion and the related opinion has been completed. In the opinion display monitor screen 131F illustrated in FIG. 20, the selected opinion and the related opinion are superposed with each other in the representative opinion display area 141. In the opinion display monitor screen 131F of the present embodiment, the selected opinion and the related opinion are superposed with the representative opinion such that the representative opinion is placed on a front-end surface of the monitor screen. Also, in the opinion display monitor screen 131F, the selected opinion display area 144 emptied is displayed and displaying within the related opinion display area 145 emptied is displayed.

Further, the student names associated with each of the representative opinion, the selected opinion and the related opinion may be displayed using a tap in the present embodiment. When the tap of name is selected, the opinion associated with the name may be displayed to be placed at a front-end surface within the representative opinion display area 141 in the present embodiment. Further, in the present embodiment, a tap in which the name of student associated with the selected opinion may be displayed beside another tap in which the name of student associated with the representative opinion is displayed. Further, in the present embodiment, a tap in which the name of student associated with the related opinion may be displayed beside another tap in which the name of student associated with the selected opinion is displayed.

Next, a process of the label display unit 287 of the present embodiment will be described. In the present embodiment, it is possible to display a label which indicates the basis viewpoint on which the teacher selected the representative opinion and the selected opinion within the representative opinion display area 141.

FIG. 21 is a flowchart explaining the process of a label display unit.

The label display unit 287 of the present embodiment refers to the label database 240 to acquire the label information (step S211). Subsequently, the label display unit 287 prepares and displays the label information selection menu in the opinion display monitor screen 131 such that the label information selection menu is overlapped with a portion of the representative opinion display area 141 (step S212).

Subsequently, the label display unit 287 determines whether the label information is selected from the label information selection menu (step S213). When it is determined that the label information is not selected at step S213, the label display unit 287 waits until the label information is selected.

When it is determined that the label information is selected at step S213, the label display unit 287 displays the selected label information within the designated representative opinion display area 141 (step S214), and ends the process.

Herein below, a process by the label display unit 287 will be described with reference to FIG. 22, FIG. 23 and FIG. 24 in detail. FIG. 22 is a view illustrating an example of the opinion display monitor screen in which a label information selection menu is displayed. The label information selection menu 151 in which a list of label information is displayed within the representative opinion display area 141 is displayed in the opinion display monitor screen 131G illustrated in FIG. 22.

When the cursor is placed within, for example, the representative opinion display area 141 and a particular manipulation is performed, the label display unit 287 of the present embodiment may determine that the representative opinion display area 141 in which the label information list menu 151 is displayed is selected.

The label information selection menu 151 of the present embodiment is displayed such that at least a portion of the label information selection menu is overlapped with the representative opinion display area 141. In the present embodiment, a portion of the label information selection menu 151 is displayed to be overlapped with the representative opinion display area 141 and thus, it makes possible for the teacher to know which representative opinion the label is assigned to.

FIG. 23 is a view illustrating an example of the opinion display monitor screen in which label information is selected from the label information selection menu. The opinion display monitor screen 131G illustrated in FIG. 23 illustrates an example in which the label information 152 is selected in the label information selection menu 151.

FIG. 24 is a view illustrating an example of the opinion display monitor screen in which the selected label information is displayed on the representative opinion display area.

The selected label information 152 is displayed within the representative opinion display area 141 in the opinion display monitor screen 131H illustrated in FIG. 24.

In the present embodiment, the selected label information 152 is displayed within the representative opinion display area 141 as described above and thus, it makes possible for the teacher to know the basis viewpoint on which the opinions are arranged in the representative opinion display area 141. In the example of FIG. 24, the fact that the opinion of Mr. DD is the representative opinion, the opinion of Mr. GG is the selected opinion, and the opinion of Mr. BB is the related opinion among the opinions arranged in the representative opinion display area 141 may be known from a position of the tap. Further, it may be seen that the opinions arranged in the representative opinion display area 141 are grouped on the basis of a viewpoint displayed in the label information 152, that is, the viewpoint of “worrying about the economic aspect”.

Next, a process of deleting the relating line by the relating line management unit 286 will be described with reference to FIG. 25 and FIG. 26. FIG. 25 is a view illustrating an example of the opinion display monitor screen in which the relating line is deleted.

The relating line management unit 286 of the present embodiment deletes the relating line 146 from the opinion display monitor screen 131D, for example, when the trajectory 147 of the cursor trespasses the relating line 146 in the opinion display monitor screen 131D in which in the relating line 146 is displayed.

The relating line 146 connecting the opinion of Mr. GG and the opinion of Mr. BB is deleted in an example of FIG. 25. In this case, the related opinion specifying unit 285 deletes the student ID12307 of Mr. GG stored in the selected opinion column associated with the student ID of Mr. BB in the opinion database 230.

FIG. 26 is a view illustrating an example of the opinion display monitor screen in which the relating line is deleted. The relating line of the selected opinion display area 144 and the related opinion display area 145 are deleted in the opinion display monitor screen 131I illustrated in FIG. 26. Accordingly, in an example of FIG. 26, the opinion displayed in the related opinion display area 145 becomes an opinion which is not a related opinion of the representative opinion, and even when the selected opinion displayed in the selected opinion display area 144 is moved, the opinion displayed in the display area 145 is not moved. That is, the relating line of the present embodiment is a selection tool that makes select whether the related opinion is to be grouped as the same group as the representative opinion.

Next, a case where the plurality of representative opinions are selected in the opinion display monitor screen will be described.

FIG. 27 is a view illustrating an example of the opinion database in which the plurality of representative opinions are selected. FIG. 27 illustrates a case where the opinion associated with the student ID12306 is selected as the representative opinion in addition to the opinion associated with the student ID12304 and the opinion associated with the student ID12305 is selected as the selected opinion related to the representative opinion.

When the opinion associated with the student ID12306 is selected as the representative opinion, the representative opinion reception unit 282 turns ON the representative opinion flag associated with the student ID12306. Further, when the opinion associated with the student ID12305 is selected as the selected opinion, the selected opinion reception unit 283 turns ON the selected opinion flag associated with the student ID12305. Also, the selected opinion reception unit 283 stores the student ID12306 associated with the representative opinion in the representative opinion column associated with the student ID12305.

Here, the related words in the keywords associated with the student ID12306 and the related word associated with the student ID12305 are “biosis”, “life”, “abortion” and “death”. Accordingly, the related opinion specifying unit 285 specifies the opinion which includes the keywords coincided with the four related words in the keywords as the related opinion. The opinion associated with the student ID12301 is specified as the related opinion in an example of FIG. 27. Accordingly, the related opinion specifying unit 285 stores the student ID12305 associated with the selected opinion in the selected opinion column associated with the student ID12301.

FIG. 28 is a view illustrating an example of the opinion display monitor screen in which the plurality of representative opinions are selected. The area in which the opinion associated with the student ID12306 selected as the representative opinion is displayed becomes the representative opinion display area 181 in the opinion display monitor screen 131J illustrated in FIG. 28. Further, the label information 153 is displayed in the representative opinion display area 181 in an example of FIG. 28. Accordingly, it may be seen that the opinions of the respective students are arranged in the opinions grouped on the basis of the viewpoint of “worrying about economic aspect” and the opinions grouped on the basis of the viewpoint of “preciousness of life” in the opinion display monitor screen 131J.

In the present embodiment, for example, when the opinion unfolding display button 16 displayed in the opinion display monitor screen 131J is manipulated (touched), the grouped opinions are unfolded and displayed.

FIG. 29 is a view illustrating an example of a unfolding display monitor screen in which the opinions are unfolded and displayed. The representative opinion, the selected opinion and the related opinion are displayed in the same monitor screen in the unfolding display monitor screen 132 illustrated in FIG. 29. It is desirable to display the other opinions with being centered around the representative opinion in the unfolding display monitor screen 132. For example, in the example of FIG. 29, the opinions grouped in the same group of the representative opinion display area 141 “A” are displayed in an area 291. In the area 291, the selected opinion display area 145A in which the selected opinion is displayed and the related opinion display area 144A in which the related opinion is displayed are unfolded and displayed with being centered around the representative opinion display area 141A. Further, the label information 152 (see, for example, FIG. 23) selected in the representative opinion display area 141A is displayed in the area 291.

Further, in the example of FIG. 29, the selected opinion and the related opinion grouped in the same group as the representative opinion display area 181A are displayed in the area 292. Similar to the area 291, the label information 153 (see, for example, FIG. 28) selected in the representative opinion display area 181A is displayed in the area 292.

Further, when the button 162 is manipulated (touched) in the unfolding display monitor screen 132, the display control unit 281 of the present embodiment restores displaying of the display manipulation device 21 from unfolding the display monitor screen 132 to the opinion display monitor screen 131.

In the present embodiment, as described above, the representative opinion, the selected opinion and the related opinion, and the label information indicating the viewpoint for grouping are concurrently displayed for each group and thus, it makes possible for the teacher or the student to readily view how the opinions of the respective students are grouped.

Further, the related opinion related to the representative opinion is specified using the related words extracted from the keywords obtained from each of the representative opinion (e.g., first opinion information) and the selected opinion (e.g., second opinion information) selected by the teacher in the present embodiment. Accordingly, the viewpoint when the teacher selects the representative opinion is determined and the opinions may be grouped based on the viewpoint in the present embodiment.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A computer-readable storage medium storing a grouping support program of opinion information that, when executed by a computer, performs a grouping support method comprising:
specifying a related opinion information related to a first opinion information and a second opinion information among a plurality of collected opinion information based on a related word guided from the first opinion information and the second opinion information selected from the plurality of collected opinion information; and
grouping the specified related opinion information in the same group as the first opinion information and the second opinion information.

2. The computer-readable storage medium according to claim 1, wherein the specifying defines a word that is common to words associated with the first opinion information including a word obtained by analyzing the first opinion information and words associated with first opinion information including another word obtained by analyzing the second opinion information as the related word.

3. The computer-readable storage medium according to claim 2, wherein the grouping support method further comprising:
associating the word obtained by analyzing the opinion information with the opinion information to store the word in a database; and
storing the plurality of words associated with the word obtained by analyzing the opinion information in the similar word dictionary in the database such that the plurality of words are associated with the opinion information when a storage unit that stores a similar word dictionary in which a plurality of similar words are associated with each other is retrieved and the word obtained by analyzing the first opinion information is included in the similar word dictionary.

4. The computer-readable storage medium according to claim 3, wherein the specifying defines the opinion information in which a word coincided with the related word is present in the words associated with the opinion information in the database as the related opinion.

5. The computer-readable storage medium according to claim 3, wherein the specifying, in the opinions stored in the database,
turns ON a first opinion flag with respect to the opinion selected as the first opinion information,
turns ON a second opinion flag with respect to the opinion selected as the second opinion information to associate an identifier identifying the first opinion information with the second opinion information, and
stores the related opinion to be associate with the another identifier identifying the second opinion information.

6. The computer-readable storage medium according to claim 1, wherein the grouping support method further comprising: displaying a selection tool which causes to select whether the related opinion is to be grouped in the group represented by the first opinion information in a display device.

7. The computer-readable storage medium according to claim 6, wherein the selection tool is a relating line connecting the related opinion and the second opinion information displayed in the display devices,
the specifying deletes an identifier identifying the second opinion information associated with the related opinion in the database when input of the trajectory trespassing the relating line is detected, and
the displaying clears display of the relating line from the display device.

8. A grouping support method for electronic terminal comprising:
specifying a related opinion related to a first opinion information and a second opinion information among a plurality of collected opinion information based on a related word guided from the first opinion information and the second opinion information selected from the plurality of collected opinion information; and
grouping the related opinion information in the same group as the first opinion information and the second opinion information.

9. A grouping support server comprising:
a related opinion specifying unit configured to specify a related opinion related to a first opinion information and a second opinion information among a plurality of collected opinion information based on a related word guided from the first opinion information and the second opinion information selected from the plurality of collected opinion information; and
a grouping unit configured to group the related opinion information in the same group as the first opinion information and the second opinion information.
